(19) United States
(12) Patent Application Publication
(10) Pub. No.: US 2026/0053704 A1
(43) Pub. Date: Feb. 26, 2026

(54) SYSTEMS AND METHODS FOR ICE BATH TEMPERATURE CONTROL AND MANAGEMENT

(71) Applicant: Ice Barrel, LLC, Leawood, KS (US)

(72) Inventors: Wyatt Ewing, Sugarcreek, OH (US); Nicholas Goodin, Washington, IL (US)

(73) Assignee: Ice Barrel, LLC, Leawood, KS (US)

(21) Appl. No.: 19/306,082

(22) Filed: Aug. 21, 2025

Related U.S. Application Data
(60) Provisional application No. 63/685,417, filed on Aug. 21, 2024.

(51) Int. Cl. A61H 33/00

(52) U.S. Cl. CPC A61H 33/0095; A61H 2033/0058; A61H 2201/0184; A61H 2201/0214; A61H 2201/501; A61H 2201/5046; A61H 2201/5082; A61H 2201/5084; A61H 2201/5087

(57) ABSTRACT

Systems and methods are disclosed for ice bath temperature control and management for ice baths and cold plunge tanks are disclosed. A chiller unit, connected to the plunge tank through a high-flow circulation system with quick-connect fittings and valves, uses a vapor-compression refrigeration system and advanced sensing to achieve precise temperatures, even in high ambient conditions, while reducing power consumption compared to convention systems. Local control of the chiller is provided through an onboard graphical interface and multifunction rotary knob, remote control of the chiller is provided through a mobile application on a user device. A monitoring system tracks chiller and system parameters such as water flow, temperature, ambient conditions, and tilt orientation, and uses a predictive time-to-temperature engine to optimize cooling start times based on real-time and historical data. The system supports real-time alerts, protective shutdowns, and over-the-air software updates.

### CROSS REFERENCE TO RELATED APPLICATIONS

This application claims priority to U.S. Provisional Patent Application Ser. No. 63/685,417, filed on Aug. 21, 2024, the disclosure of which is hereby incorporated herein in its entirety by reference.

### BACKGROUND

Cold water immersion therapies, such as ice baths and cold plunges, have gained popularity in recent years due to their health benefits. Some benefits have been associated with reductions in inflammation, accelerated recovery following physical exertion, improved circulation, enhanced immune function, stress relief, and promotion of overall mental well-being. As a result, cold plunge systems have become common in both residential and professional environments, including athletic training facilities and wellness centers.

However, conventional approaches to cooling water in cold plunge tanks remain largely unchanged from conventional methods, which are generally inefficient. One commonly employed method involves filling a plunge tank with water and adding large quantities of ice, such as commercially purchased bags of ice bags or frozen water containers, to achieve the desired water temperature. This approach has several disadvantages and shortcomings. For example, procuring, transporting, and manually adding ice requires substantial effort. And, maintaining a stable or desired water temperature in the plunge tank by simply adding ice is difficult, as the melting ice needs periodic replenishment, which typically results in undesirable fluctuations of the water temperature. Such fluctuations limit the ability to maintain consistent therapeutic conditions. Thus, it can be seen that there remains a need in the art for controlling and managing the water temperature in ice bath and cold plunge tank applications.

### SUMMARY

The present invention relates to systems and methods for controlling and managing the temperature of water in cold therapy applications, such as ice baths and cold plunge tanks. In some embodiments, a network-connected chiller system includes a chiller unit in fluid communication with a cold plunge tank through a chiller circulation system. The chiller unit may be equipped with advanced cooling and sensing technology to achieve and maintain precise water temperatures, for example as low as 37° F. (2.8° C.) even in ambient temperatures of up to 120° F. (48.9° C.), while simultaneously operating at reduced amperage as compared to conventional water chiller systems.

In various embodiments, the chiller unit may incorporate a vapor-compression refrigeration system, a high-flow water pump system, and IP67-rated components for operation in various and diverse environments. The chiller circulation system may include hoses, quick-connect fittings, ball valves, and elbow fittings arranged for efficient water flow between the chiller unit and the cold plunge tank.

The chiller unit may support both local and remote operation. In one embodiment, local control may be provided through an onboard graphical user interface (GUI) with a multifunction rotary control knob for navigation, selection, and adjustment of chiller system parameters, such as a target water temperature and operation schedules. In other embodiments, remote control of the chiller operation may be provided through a Wi-Fi-enabled mobile application or web interface, allowing users to adjust temperature settings, schedule cooling cycles, monitor system performance, and receive real-time alerts of temperatures, malfunctions, and other system related parameters. In some embodiments, multi-user access and management of multiple chiller units may also be supported.

In some embodiments, advanced monitoring and automation may be provided through an integrated monitoring system. The monitoring system can include multiple sensors to track water flow, water temperature, ambient temperature, environmental conditions, and other system and operational parameters. In preferred embodiments, a time-to-temperature engine can determine the optimal time to begin cooling in order to meet a scheduled target temperature and timee, using real-time sensor data, historical performance data, and external data sources such as weather conditions and altitude. The time-to-temperature engine may be implemented with predictive algorithms or machine learning to refine performance and accuracy over time.

The monitoring system may incorporate protection mechanisms, such as freeze prevention, low-flow detection, and tilt detection via an onboard accelerometer to prevent damage from improper handling of the system and its components. In some embodiments, the system may provide notifications to the user in response to operational anomalies, maintenance requirements, or protective shutdown events. Over-the-air software updates can be delivered to the chiller unit to provide feature enhancements and performance improvements without user intervention.

In some embodiments, the system includes specialized quick-connect hose adapters, ball valves with quick-connect inlets and outlets, and elbow fittings optimized for high-flow operation. These components can facilitate rapid setup, maintenance, and reconfiguration of the chiller circulation system while ensuring minimal flow restriction and durability in wet or outdoor environments.

The disclosed systems and methods enable efficient, precise, and user-friendly control of water temperature in cold plunge tanks, offering significant improvements in convenience, energy efficiency, and operational reliability over conventional ice-based cooling methods.

Traditional cooling methods generally lack the capability for remote temperature monitoring and control. The absence of such functionality prevents users from preparing a cold plunge in advance, maintaining a defined temperature range over time, or tailoring operating parameters to individual preferences. Thus, it can be seen that there exists a need in the art for a more sophisticated and energy-efficient system capable of achieving and maintaining precise water temperatures in cold plunge tanks, while providing enhanced user convenience through advanced monitoring, control, and automation capabilities.

### BRIEF DESCRIPTION OF THE DRAWINGS

It is believed that certain embodiments will be better understood from the following description taken in conjunction with the accompanying drawings, in which like references indicate similar elements and in which:

FIGS. 1 and 2 depict a chiller unit in fluid communication with a cold plunge tank via a chiller circulation system in accordance with an exemplary embodiment of the present invention.

FIGS. 3 and 4 depict additional isometric views of the chiller unit of FIG. 1.

FIG. 5 is a top view of the chiller unit of FIG. 1 in accordance with an exemplary embodiment of the present invention.

FIGS. 6 and 7 are left and right side views, respectively, of the chiller unit of FIG. 1 in accordance with an exemplary embodiment of the present invention.

FIGS. 8, 9, 10, and 11 are screenshots of a user interface for controlling the chiller unit of FIG. 1 that may be displayed on a computing device of a user of the chiller unit, in accordance with an exemplary embodiment of the present invention.

FIG. 12 is a schematic depiction of components and functionality of a chiller monitoring system for use with the chiller unit of FIG. 1 in accordance with exemplary embodiments of the present invention.

FIG. 13 is a top perspective view of interface controls and display of a chiller unit in accordance with an exemplary embodiment of the present invention.

FIGS. 14 and 15 depict a quick connect hose for use with the chiller unit, cold plunge tank, and/or chiller circulation system of FIG. 1 in accordance with an exemplary embodiment of the present invention.

FIG. 16 depicts an exploded view of a ball valve with a quick connect outlet for use with the chiller unit, cold plunge tank, and/or chiller circulation system of FIG. 1 in accordance with an exemplary embodiment of the present invention.

FIGS. 17, 18, and 19 depict a quick connect fitting for use with the chiller unit, cold plunge tank, and/or chiller circulation system of FIG. 1 in accordance with an exemplary embodiment of the present invention.

FIGS. 20, 21, and 22 depict an elbow fitting for use with the chiller unit, cold plunge tank, and/or chiller circulation system of FIG. 1 in accordance with an exemplary embodiment of the present invention

### DETAILED DESCRIPTION

Various non-limiting embodiments of the present disclosure will be described herein to provide an overall understanding of the principles of the structure, function, and use of the systems and methods disclosed. One or more examples of these non-limiting embodiments are illustrated in the selected embodiments disclosed and described in detail with reference made to the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems and methods disclosed herein are described in detail by way of examples and with reference to the figures. The examples discussed herein are examples only and are provided to assist in the explanation of the systems and methods described herein. None of the features or components shown in the drawings or discussed below should be taken as mandatory for any specific implementation of any of these systems or methods unless specifically designated as mandatory. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible.

It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The systems and methods disclosed herein generally relate to a networked chiller system specifically designed for cold therapy applications. The system comprises a chiller unit equipped with advanced cooling and sensing technology, which enables precise temperature control and efficient operation. The chiller unit can be integrated with a variety of different cold plunge tanks, allowing for versatile installation and compatibility with existing therapy setups.

In accordance with some embodiments of the present disclosure, the chiller unit can cool water to temperatures as low as 37° F. (2.8° C.), even in ambient temperatures up to 120° F. (48.9° C.). This operating range is achieved through the use of a ½ HP (horsepower) system that intelligently integrates an energy-smart compressor and advanced sensing technology. The system's efficiency is further demonstrated by its low amperage requirement of only 6 amps for cooling, compared to the 15-20 amps typically required by standard chillers.

The chiller unit described herein may also include network connectivity, which allows for remote control and scheduling via a mobile application, and monitoring system parameters. The Wi-Fi-enabled chiller unit can be managed through an associated mobile application, for example, providing users with the ability to prepare their cold plunge tank in advance to ensure the desired or optimal water temperature at the desired time. This feature further promotes energy conservation by allowing users to program the chiller to operate only when necessary. In addition to its Wi-Fi connectivity and mobile app integration, the chiller unit also supports manual operation via controls and a display built into the chiller unit to accommodate local control and users who may not have access to a wireless network.

The chiller unit can preferably withstand various environmental conditions, including outdoor settings, having IP67-rated components (ingress protection) that provide protection against dust and water entering the unit. Thus, the chiller unit and associated advanced cooling and sensing technology in accordance with the present invention provide an integrated system that enhances the chiller unit's performance, energy efficiency, and user experience by coordinating various operational aspects of the system. The advanced cooling and sensing technology serves as the central intelligence that manages and optimizes the chiller unit's multiple functions.

As described herein below, the cooling and sensing technology preferably includes a time-to-temperature engine which predicts and optimizes the cooling process to ensure the water reaches the desired temperature exactly when needed. The system may use continuous data collection from chiller units in the field, analyzing factors such as current water temperature, ambient air temperature, and historical usage patterns. By tuning the software based on this real-world data, the time-to-temperature engine improves its accuracy and efficiency over time. This approach ensures that the chiller unit operates only when necessary, maximizing both performance and energy savings.

The embodiments disclosed herein may also include system protections to safeguard and monitor critical components and operational parameters to prevent potential damage. Multiple sensors can track water flow, temperature, and environmental conditions. For example, if the system detects a risk of freezing due to low water temperatures, active protective measures can notify the user and/or adjust the temperature to prevent freezing. Similarly, water flow rates may be monitored to identify blockages or low flow conditions, triggering alerts if maintenance or corrective actions are required.

Furthermore, the chiller unit can manage energy usage intelligently by adjusting cooling power based on real-time conditions and user preferences, minimizing any unnecessary energy consumption. The system can also incorporate scheduling features that adjust the chiller unit's operation with the user's routine, further increasing the efficiency of operating the chiller system. During periods of inactivity, the chiller unit can automatically enter a low-energy state while maintaining readiness for the next scheduled session.

Using the scheduling and automation functionality described herein, users can set precise times for cooling sessions. The system then ensures that the chiller unit starts cooling at the optimal time to reach the desired temperature for the scheduled session. If a user manually initiates a cooling session, the request can be prioritized, but the chiller unit may smoothly transition back to the scheduled routine once the manual session is completed. This seamless integration of scheduling and real-time management ensures that the chiller unit is always ready when needed, without wasting energy.

In various embodiments, a notification system can provide users with real-time alerts and updates regarding the chiller unit's status, including temperature adjustments, maintenance needs, and potential issues. These notifications can keep users informed and engaged with the chiller unit's operation, ensuring timely interventions when necessary. For example, if a critical condition is detected, such as low water flow or high refrigeration pressure, a notification can be sent to the user, advising the user of required action to prevent damage and maintain optimal performance. In some embodiments, the system may automatically act on detected critical conditions to mitigate any potential damage. And, in some embodiments, the system may receive software updates delivered directly to the chiller unit over-the-air (e.g., via Wi-Fi), ensuring that all connected devices receive the latest enhancements and bug fixes without user intervention. This update process preferably occurs during off-peak hours to avoid disrupting the chiller unit's operation.

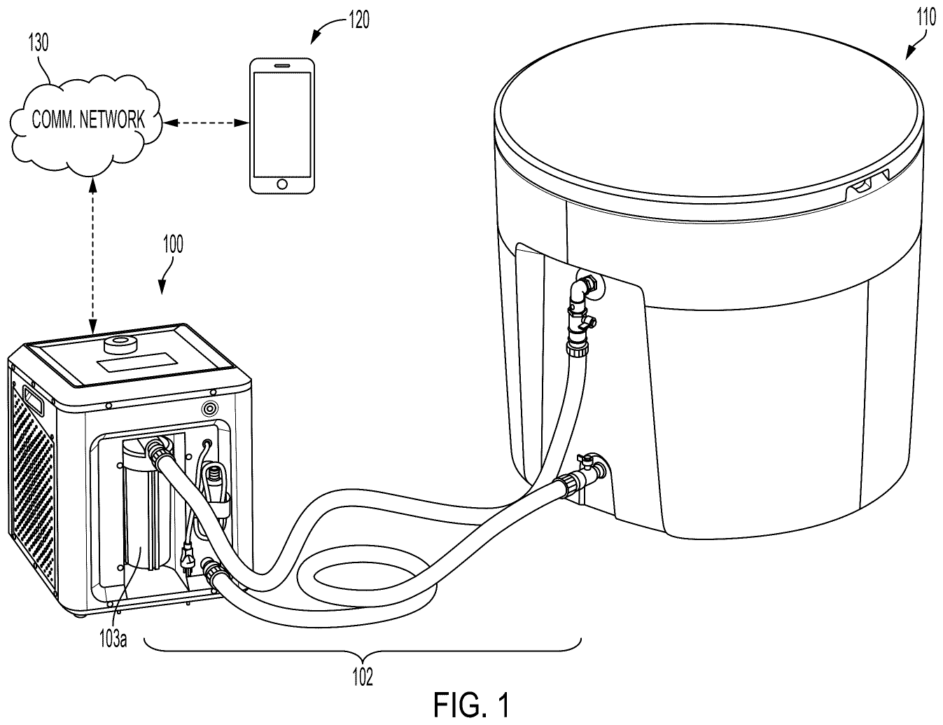

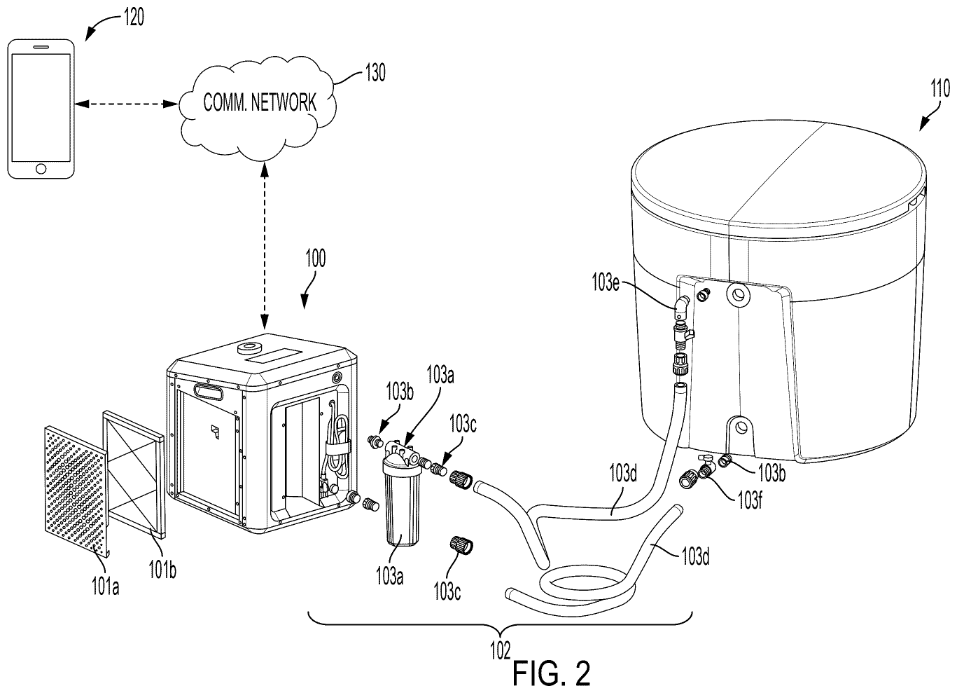

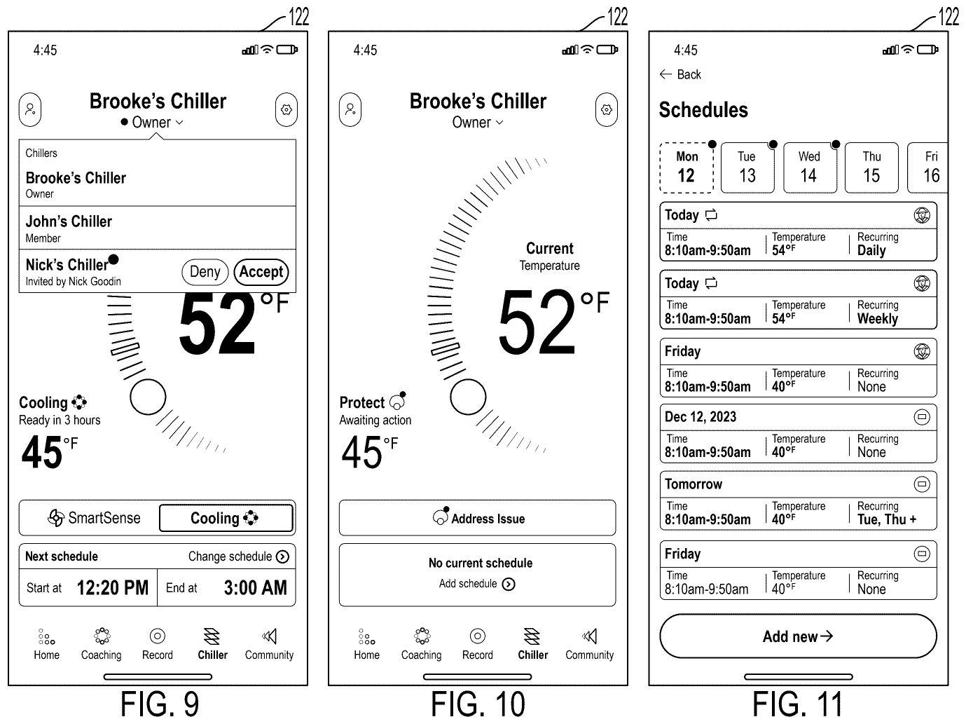

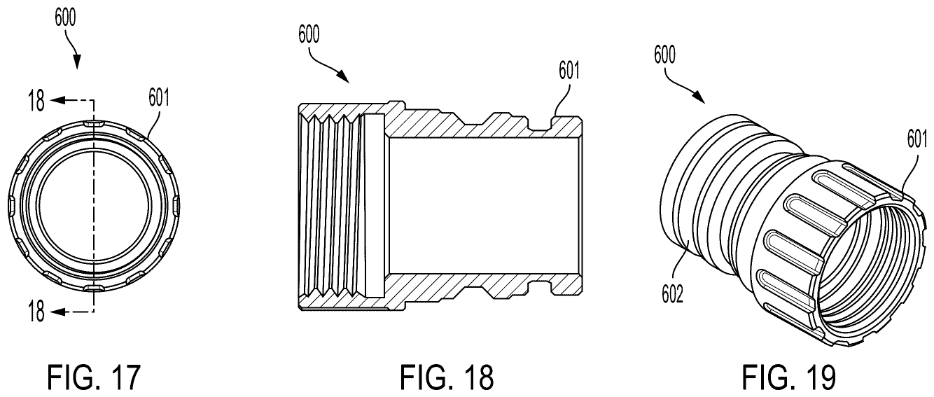

The configuration and operation of the chiller system will now be described with reference to FIGS. 1 through 22. Looking first to FIGS. 1 and 2, an exemplary chiller unit 100 in fluid communication with a cold plunge tank 110 through a chiller circulation system 102 is depicted. The chiller circulation system 102 is shown in exploded view for clarity in FIG. 2. Generally, the chiller circulation system 102 circulates chilled water from the chiller unit 100 to the cold plunge tank 110 and back again, maintaining the desired water temperature for cold therapy sessions.

The chiller circulation system 102 preferably includes a supply line and a return line configured to circulate chilled water from the chiller unit 100 to the cold plunge tank 110. The supply line, also known as the supply piping, carries the chilled water from the chiller unit 100 to the cold plunge tank 110. The return line, or return piping, carries the water back from the tank to the chiller for re-cooling. The pipes, hoses, and valves are connected using a variety of fittings, such as couplings, elbows, tees, and adapters, which can be specially adapted for high-flow operation, as described in more detail below. Thus, as best seen in FIG. 2, the chiller circulation system may include a water filter 103a, pipe adapter fittings 103b, quick connect fittings 103c, hoses 103d, elbow adapters 103e, and a ball valve 103f, all connected to form the chiller circulation system 102. It should be understood that the specific arrangement of hoses, fittings, adapters, and valves may be varied from the embodiment shown without deviating from the scope of the present invention.

As will be described in more detail below, the chiller unit 100 includes an air filter 101b positioned behind a perforated panel 101a so that ambient air may be drawn into the chiller unit 100 and across condenser coils to draw heat from the system. And, as shown in FIG. 2, the chiller unit 100 includes wireless communication functionality, such as Wi-Fi, to allow communication with the chiller unit from a user device 120 through a wide area or local communications network 130 such as the Internet or a local network.

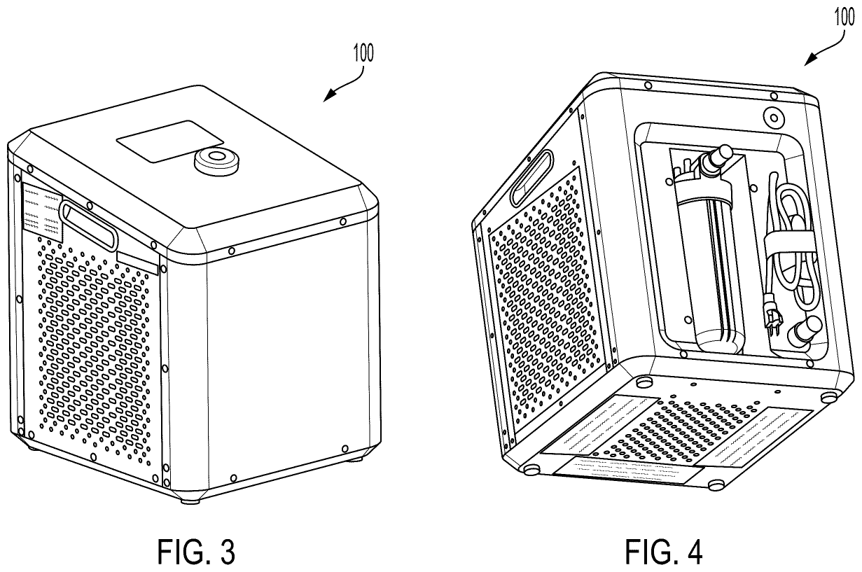

Turning to FIGS. 3 and 4, additional views of the chiller unit 100 are depicted. Chiller unit 100 is configured to cool the water in the cold plunge tank 110 using a vapor-compression refrigeration cycle, while providing network connectivity for remote control and operation, monitoring, and diagnostics. The chiller unit 100 may include a compressor, a condenser, an expansion valve, and an evaporator, which work together to remove heat from the water and transfer it to the surrounding air. The compressor compresses the refrigerant gas, such as R290 refrigerant, for example, to raise its pressure and temperature. The high-pressure, high-temperature refrigerant gas then moves to the condenser, which is a heat exchanger that allows the hot, high-pressure refrigerant gas to release its heat to the surrounding air.

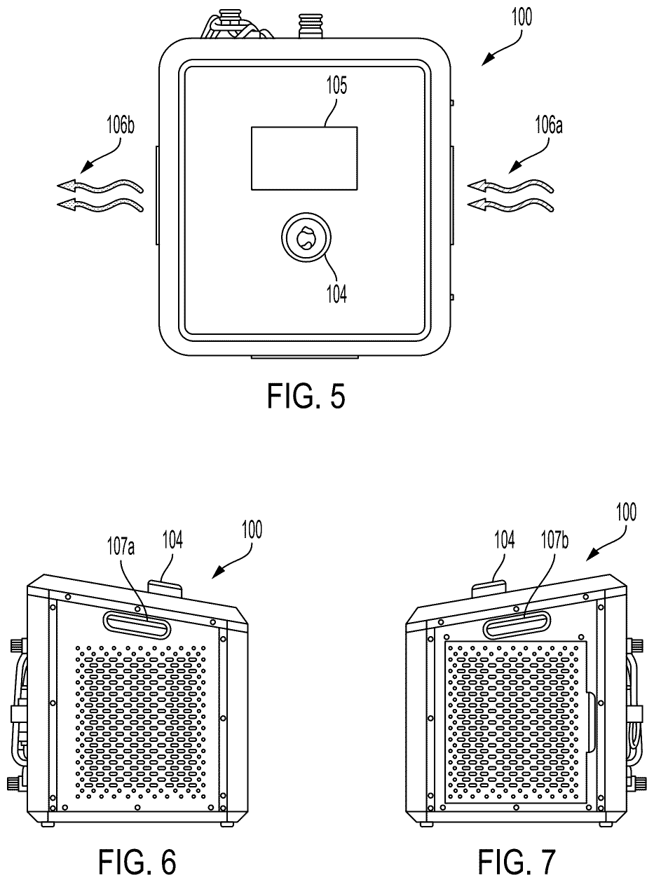

Looking to FIG. 5, the condenser in the chiller unit 100 preferably draws in cool supply air 106a from the environment, with an internal fan configured to blow the supply air 106a across the condenser coils to transfer heat from the refrigerant in the coils to the supply air. As the air passes over the condenser coils, it absorbs the heat from the refrigerant, becoming hot air 106b that is then expelled from the chiller unit. Air drawn into the chiller unit 100 is preferably drawn through the perforated panel 101a on the side of the unit and through an air filter 101b (as best seen in FIG. 2) to remove dust and contaminants from the incoming air.

After passing through the condenser, the high-pressure liquid refrigerant passes through an expansion valve, which reduces its pressure and temperature. This process causes the refrigerant to expand and partially evaporate, creating a cold, low-pressure mixture of liquid and gas. The cold, low-pressure refrigerant mixture then enters the evaporator, another heat exchanger, where it absorbs heat from the water circulating through the chiller unit 100 system via a high flow water pump system, causing the water to cool down. As the refrigerant absorbs heat, it evaporates completely, turning into a low-pressure gas, which then returns to the compressor, where the cycle begins again.

As previously discussed with respect to FIGS. 1 and 2, the chiller unit 100 of the present invention is preferably equipped with network connectivity, allowing for remote control and monitoring of the system via a mobile application executing on a mobile communication device 120. The chiller unit 100 can include, for example, a Wi-Fi module or other wireless communication technology that enables it to connect to a local network or the internet, depicted as communication network 130 in FIGS. 1 and 2. Users can access the chiller's controls and settings through a dedicated mobile application, which may provide the user with the ability to adjust temperature settings, schedule cooling cycles, and monitor the system's performance.

Thus, an application executing on the mobile communication device 120 can provide a user interface and can also communicate with the chiller unit 100 via a wireless connection, sending commands and receiving data from the chiller's onboard control system. The chiller unit 100 can include a chiller monitoring system for monitoring various real-time conditions and parameters, such as water temperature, ambient temperature, and compressor performance. In some embodiments, the chiller monitoring system and/or the mobile application can also gather data from other data sources, such as real-time weather data, which can be used when determining the cooling cycles required to efficiently and optimally satisfy the water temperature requirements for scheduled uses of cold plunge tank.

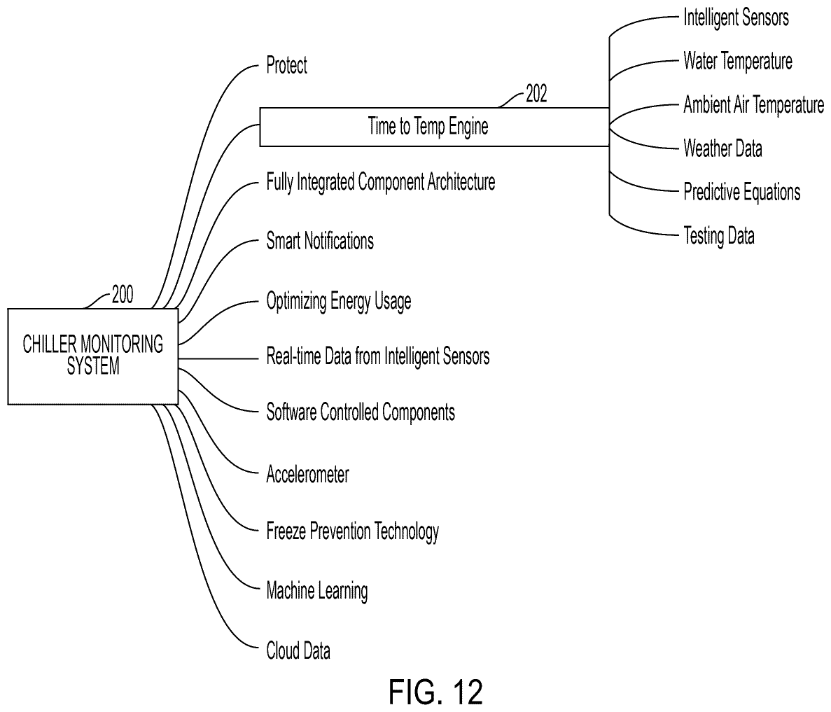

As will be discussed below with respect to FIG. 12, the user application allows access to various functionality of the chiller system. For example, users of the cold plunge tank 110 can schedule uses of the cold plunge tank (i.e., set the date, time, and water temperature) and also adjust temperature settings remotely, which can help to reduce energy consumption and ensure that the cold plunge tank is ready for use when needed. Furthermore, real-time monitoring and alert features of the mobile application can help to identify potential issues with the chiller system, thereby reducing the risk of unexpected downtime and costly repairs. The networked connectivity also enables the chiller unit to receive software updates and performance enhancements remotely, ensuring that the system remains up-to-date and operate at peak efficiency.

Looking still to FIGS. 5, 6, and 7, the chiller unit may also include local control via a rotary knob 104 and display 105, with the unit presenting a graphical user interface (GUI) to the user to allow selection of various functions and controls by rotating the knob and selecting desired functions. Lifting handles 107a, 107b positioned on the sides of the chiller allow a user to easily move and position the chiller unit as desired

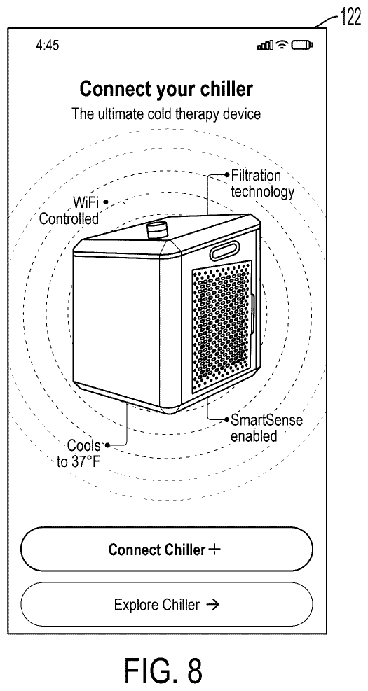

Turning to FIGS. 8, 9, 10, and 11, depicted are exemplary embodiments of screen shots 122 of a user interface that may be displayed on a user's computing device, such the mobile communication device 120 depicted in FIGS. 1 and 2. While the user interfaces depicted herein are in the form of a mobile application, this disclosure is not so limited. It should be understood that similar types of user interfaces may be presented through a web browser, a table computer, or other computing device, for example. In any event, the user interface 122 can allow users to remotely control, monitor, and schedule the operation of the networked chiller system. The user interface 122 can enable users to easily access and adjust various settings and parameters.

The user interface 122 can include a main dashboard or home screen that displays key information about the chiller system's current status, such as the water temperature in the cold plunge tank 110, the chiller's operating mode, and the next scheduled event. The dashboard may also include visual indicators, such as graphs or charts, to provide users with a quick overview of the chiller's performance or status. A scheduling screen can allow users to create and manage cooling schedules for the chiller system. Users can set specific times and dates for chiller use and indicate the desired water temperature. As provided below, however, the system can intelligently cool the water in the plunge tank prior to each scheduled use based on real-time operational conditions, which efficiently optimizes the use of the chiller unit.

The user interface 122 can also include a remote control screen, which allows users to manually control the chiller system's operation from their mobile device. This screen can include buttons or sliders for turning the chiller on or off, adjusting the water temperature, or setting the operating mode. The user interface 122 of the present disclosure can provide a comprehensive and user-friendly means for interacting with the networked chiller system. By offering a range of features and options, the interface empowers users to optimize the chiller's performance, monitor its operation, and ensure that their cold plunge tank is always ready for use. The intuitive design and clear presentation of information make it easy for users to manage their chiller system remotely, reducing the need for manual intervention and enhancing the overall user experience.

In some example embodiments, the user interface 122 can include a home screen information center that provides real-time updates on the chiller unit's status, including current temperature, target temperature, and operational mode. The user interface 122 can also include, for example, a dynamic dial to allows users to track and adjust the cooling process by sliding the setpoint temperature. Beneficially, the user interface 122 of the mobile device can effectively function as remote control from any location, either local or distant from the chiller unit. In this regards, users can monitor and control the chiller unit remotely via the mobile application, allowing adjustments to be made from any location. This aspect provides user convenience, ensuring the chiller unit is always ready when needed, even if the user is not physically present to locally interact with the chiller. In some embodiments, the mobile application provide multi-user management. With multiple users being supported, collaborative management of the chiller unit can be provided. Further, users can invite others, manage their access, and coordinate schedules to prevent conflicts, for example. The mobile application can also allow users to set one-time or recurring schedules, ensuring the chiller unit is ready when needed. The system can work seamlessly with the time-to-temperature engine described herein to optimize energy efficiency and user convenience. In some embodiments, the mobile application can allow for users to manage multiple chiller units simultaneously. This feature is particularly useful for users who own or manage more than one chiller unit, providing a centralized interface for all their devices. Thus, users can switch between different chiller units, monitor their statuses, and control their operations from a single mobile application. These example features make the mobile application a powerful and flexible tool for managing the chiller unit, tailored to meet the needs of both individual and multiple users in various settings.

Referring now to FIG. 12, a schematic depiction of an example chiller monitoring system 200 is shown in accordance with various embodiments of the present disclosure. The chiller monitoring system 200 can provide centralized control and real-time operational oversight for the chiller unit, integrating multiple intelligent sensors, predictive algorithms, and automated protection mechanisms. In the illustrated embodiment, the chiller monitoring system 200 includes a time-to-temperature engine 202 that calculates the optimal time to initiate cooling in order to achieve a user-specified target temperature at a desired time. The time-to-temperature engine 202 can utilize real-time data from intelligent sensors as well as external data sources, such as weather data, to enhance prediction accuracy.

The intelligent sensor suite can include sensors for water temperature and ambient air temperature, as well as flow sensors, pressure sensors, and an accelerometer for detecting tilt or improper orientation of the chiller unit. In some embodiments, the accelerometer data can be used to detect if the unit was transported or positioned in a manner that could compromise compressor lubrication or alignment, prompting a protective delay before operation.

The chiller monitoring system 200 can implement freeze prevention technology by continuously monitoring water temperature and initiating protective heating or cycling operations if temperatures approach a freezing threshold. The system can also monitor for abnormal flow conditions, low water volume, or other operational anomalies.

To optimize efficiency, the chiller monitoring system 200 can run predictive equations based on real-time and historical operational data, testing data, and machine learning models. These predictive algorithms can adjust control parameters to minimize energy consumption while ensuring performance requirements are met. Optimizing energy usage can include adjusting compressor duty cycles, modulating pump speed, or shifting operational windows based on anticipated demand.

The chiller monitoring system 200 can further generate smart notifications in response to operational events, maintenance needs, or detected faults, which can be transmitted to a local display and/or a network-connected remote application. These notifications can provide actionable information to the user, including warnings of potential damage, instructions for corrective measures, or confirmation of successful operation.

The chiller monitoring system 200 is preferably implemented as a fully integrated component architecture, in which software-controlled components coordinate data acquisition, analysis, and operational commands. In some embodiments, operational data may be stored locally and/or transmitted to a cloud data service for analysis, long-term performance tracking, and over-the-air software updates. Such integration allows the system to learn from both individual-unit history and aggregated fleet data, further refining predictive accuracy and operational reliability over time.

Looking still to FIG. 12, the time-to-temperature engine 202 is operable to determine an optimized approach for cooling the water in an associated cold plunge tank based on inputs from a variety of sensors and data sources. Based on, for example, the ambient air temperature, the current water temperature, and the desired water temperature for a scheduled use of the cold plunge tank, the time-to-temperature engine can determine what time to start the cooling cycle prior to the scheduled use. In operation, the time-to-temperature engine 202 may use various inputs or data, including weather data, altitude data, predictive data, and so forth, to provide optimal operation of the chiller unit. Thus, the time-to-temperature engine 202 can calculate the optimal time required to cool water to the desired temperature based on real-time conditions. In some embodiments, the time-to-temperature engine may include machine learning, allowing the time-to-temperature engine 202 to continuously refine its algorithms using operational data, improving both accuracy and efficiency over time. This ensures that the associated chiller unit is ready exactly when needed, while conserving energy by avoiding unnecessary operation.

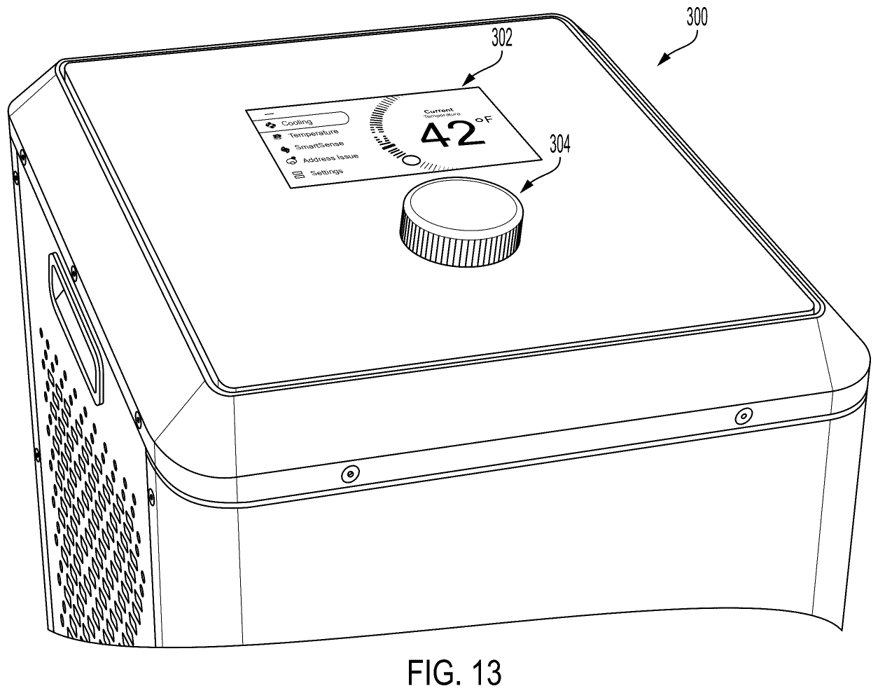

Turning now to FIG. 13, a view of the interface controls of an exemplary chiller unit 300 are depicted. In the illustrated embodiment, the chiller unit 300 includes a local graphical user interface (GUI) 302 and a multifunctional control knob 304 positioned on the top side of the unit for ease of access and visibility. The GUI 302 comprises a display screen that can present various menus, settings, and real-time information about the chiller's operation. While this configuration and orientation of interface controls is shown for illustrative purposes, it should be understood that the interface controls can be positioned at any suitable location on the chiller unit, such as the front panel or a side panel, without departing from the scope of the present disclosure. Note that the GUI 302 on the chiller allows local control while the mobile application allows a user to remotely control the chiller.

The control knob 304 may serve as the primary input device for the user interface, offering multiple interaction modes. It can be rotated both clockwise and counterclockwise to navigate through menus, adjust settings, or scroll through options displayed on the GUI 302. Additionally, the control knob 304 can be depressed, functioning as a selection or confirmation button. Through this interface, users can perform a wide range of operations and access information. For example, users can set the desired water temperature for the cold plunge tank by navigating to the temperature control menu on the GUI 302 and using the knob 304 to adjust the set point with precision. A scheduling feature accessible through the GUI 302 can allow one or more users to program the chiller's operation times, optimizing energy usage and ensuring the cold plunge tank is ready when needed.

The GUI 302 can also display various notifications to inform users of the chiller's status, maintenance requirements, and any potential issues. Furthermore, users can access and modify various settings of the chiller unit through the interface. The interface can also offer real-time monitoring capabilities, displaying current water temperature, system status, and other operational metrics. While in cooling mode, the chiller unit can actively lower the water temperature to the desired setpoint, using smart sensors to adjust for ambient air temperature and real-time water temperature. The system starts cooling before scheduled sessions to ensure readiness. While in ready mode, the chiller unit can maintain the set temperature, holding it within a ±3° F. range or other performance threshold until the end of the scheduled session. In Smart Sense mode, when not actively cooling, the chiller unit can sample water temperature every 10 minutes (or other period) and maintaining it within a 10° F. band (or other threshold) relative to the setpoint. While in a maintenance mode, the chiller unit is idle to allow for tasks such as water filter changes. A protect mode can be activated when the system detects a potentially harmful event, shutting down certain operations and notifying the user.

While the format and layout of the GUI 302 can vary based on implementation, in some embodiments the GUI 302 displays Wi-Fi connection status and current time. An information center can display the current mode and target temperature of the chiller unit. A visual representation of the cooling process can be presented via a virtual dial, indicating current and target temperatures. A control wheel can be the main navigation tool for the interface, used to select options, adjust temperature, and access the main menu. The display can activate with interaction and goes to sleep after 30 seconds of inactivity to conserve energy, for example.

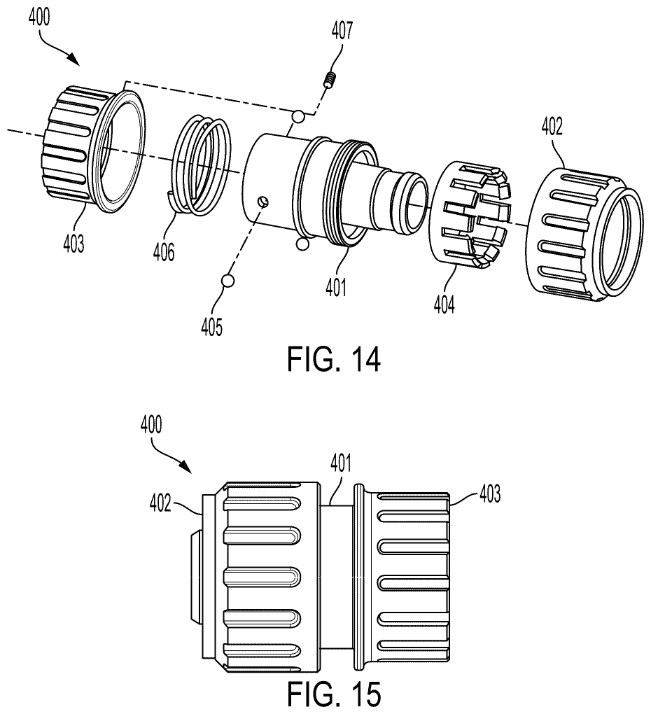

Referring now to FIGS. 14 through 22, various specialized components and connectors of a chiller circulation system which can be utilized to provide high-flow water circulation for increased efficiency and performance are depicted. The high-flow water circulation system can include quick-connect fittings and hoses with a maximum throughput diameter. This design allows for efficient cooling by ensuring a high flow rate.

Referring to FIGS. 14 and 15, an example quick connect hose adapter 400 is depicted. The quick connect hose adapter 400 can include a coupling body 401 and a pair of knobs, including a hose tightening knob 402 and a connect/release knob 403. The quick connect hose adapter 400 can also include a hose locking collet 404 and a plurality of steel balls 405. Additionally, the quick connect hose adapter 400 can include a compression spring 406 and a threaded set screw 407.

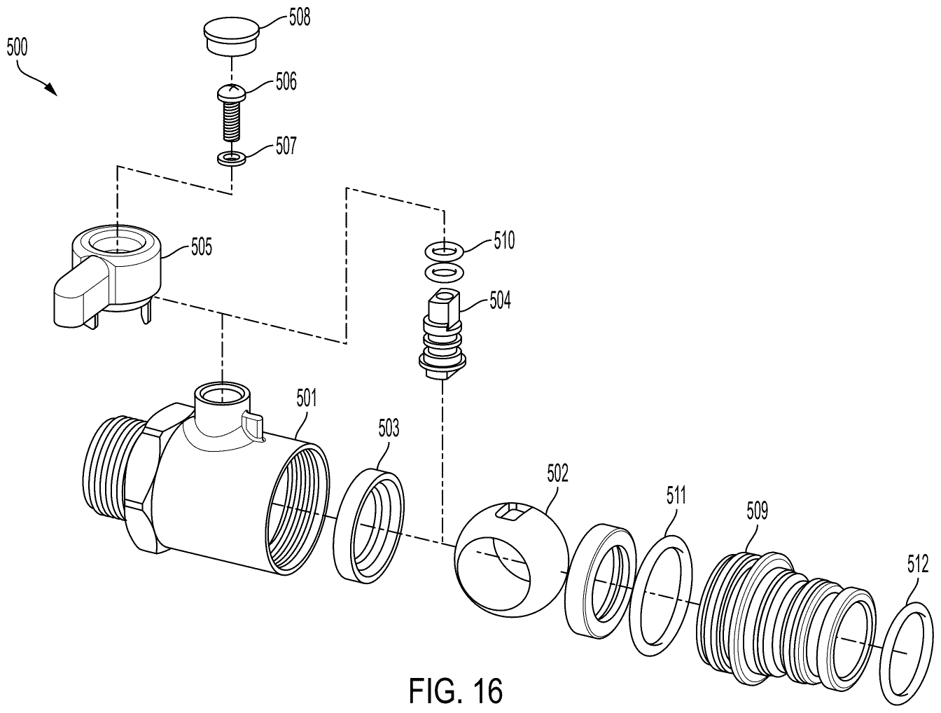

FIG. 16 depicts an exploded view of a ball valve 500 with a quick connect outlet in accordance with one non-limiting embodiment. As shown, the ball valve 500 can include a valve body 501, a ball 502, and a ball seat 503. The actuation system can include a valve stem 504, a lever 505, a screw 506, a lock washer 507, and a screw cap 508. The ball valve 500 can also include an outlet port 509, as well as a variety of O-rings 510-512.

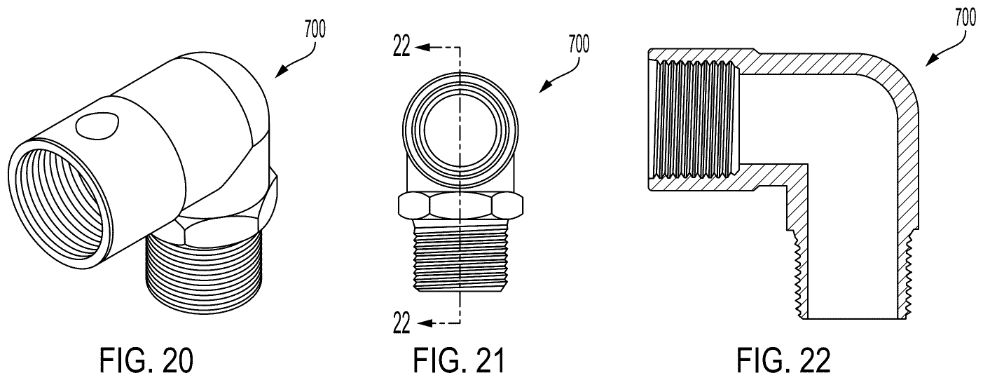

Turning to FIGS. 17, 18, and 19, a quick connect fitting 600 in accordance with one non-limiting embodiment is depicted. The quick connect fitting 600 includes a body 601 and an O-ring 602. FIGS. 20, 21, and 22 depict an elbow fitting 700 for use with the chiller unit 100, cold plunge tank 110, and/or chiller circulation system 102. In one embodiment, the elbow fitting 700 has a 90-degree bend to allow for connection between components in space-constrained installations. One end of the elbow fitting 700 can include a female NPT thread, and the other end can include a male NPT thread, allowing it to couple directly to standard threaded ports. The elbow fitting 700 can be manufactured from corrosion-resistant materials suitable for wet or outdoor environments, and in some embodiments can include internal passage diameters sized for high-flow operation to reduce restriction in the chiller circulation system.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

1. A chiller system for controlling water temperature in a cold therapy tank, comprising:
a chiller unit configured to cool water using a vapor-compression refrigeration system;
a high-flow water circulation system in fluid communication between the chiller unit and the cold therapy tank, the circulation system including at least one quick-connect fitting;
a plurality of sensors configured to monitor operational parameters including water temperature, water flow rate, and ambient temperature;
a network interface configured to enable communication between the chiller unit and a remote computing device; and
a control system configured to regulate operation of the chiller unit based on sensor data and user input received via at least one of a local graphical user interface or a remote application.

2. The system of claim 1, wherein the chiller unit is configured to achieve water temperatures of 37° F. (2.8° C.) or lower in ambient temperatures of up to 120° F. (48.9° C.).

3. The system of claim 1, wherein the control system includes a predictive time-to-temperature engine configured to determine a start time for cooling based on real-time and historical operating data.

4. The system of claim 1, wherein the network interface comprises a Wi-Fi module, and the remote computing device comprises a mobile communication device executing an application to control the chiller unit.

5. The system of claim 1, wherein the plurality of sensors further includes an accelerometer sensor configured to detect improper orientation of the chiller unit and generate an alert.

6. The system of claim 1, wherein the chiller unit and circulation system comprise IP67-rated components.

7. The system of claim 1, wherein the high-flow water circulation system includes a quick-connect hose adapter, a ball valve with a quick-connect outlet, and an elbow fitting.

8. A method of controlling water temperature in a cold therapy tank, comprising:
circulating water between a cold therapy tank and a chiller unit via a high-flow circulation system;
cooling the water in the chiller unit using a vapor-compression refrigeration system;
monitoring operational parameters including water temperature, water flow rate, and ambient temperature using a plurality of sensors;
receiving user input via at least one of a local graphical user interface or a remote application; and
controlling operation of the chiller unit based on the monitored operational parameters and the user input.

9. The method of claim 8, further comprising determining an optimal start time for cooling based on a predictive time-to-temperature engine utilizing real-time and historical data.

10. The method of claim 8, further comprising transmitting alerts to a remote computing device in response to detecting at least one of a low-flow condition, an unsafe water temperature, or improper orientation of the chiller unit.

11. The method of claim 8, further comprising updating control software of the chiller unit via an over-the-air update.

12. The method of claim 8, wherein circulating water includes connecting the chiller unit to the cold therapy tank using quick-connect fittings and valves.

13. A temperature control system for a liquid-containing tank, comprising:
a chiller unit configured to cool liquid using a vapor-compression refrigeration system;
a liquid circulation system in fluid communication between the chiller unit and the tank, the circulation system including at least one quick-connect fitting;
a plurality of sensors configured to monitor operational parameters including liquid temperature, liquid flow rate, and ambient temperature;
a network interface configured to enable communication between the chiller unit and a remote computing device; and
a control system configured to regulate operation of the chiller unit based on sensor data and user input received via at least one of a local graphical user interface or a remote application.

14. The system of claim 13, wherein the chiller unit is configured to achieve liquid temperatures of 37° F. (2.8° C.) or lower in ambient temperatures of up to 120° F. (48.9° C.).

15. The system of claim 13, wherein the control system includes a predictive time-to-temperature engine configured to determine a start time for cooling based on real-time and historical operating data.

16. The system of claim 13, wherein the network interface comprises a Wi-Fi module, and the remote computing device comprises a mobile communication device executing an application to control the chiller unit.

17. The system of claim 13, wherein the plurality of sensors further includes an accelerometer sensor configured to detect improper orientation or movement of the chiller unit and generate an alert.

18. The system of claim 13, wherein the chiller unit and circulation system comprise weather-resistant components rated for outdoor use.

19. The system of claim 13, wherein the liquid circulation system includes a quick-connect hose adapter, a ball valve with a quick-connect outlet, and an elbow fitting.

20. The system of claim 13, wherein the control system is configured to receive over-the-air software updates via the network interface.
